(19) United States
(12) Patent Application Publication
(10) Pub. No.: US 2005/0105746 A1
(43) Pub. Date: May 19, 2005

(54) Passive and active escapement for sound resonance

(76) Inventors: Patrick Lecocq, Ennevelin (FR); Claude-Annie Perrichon, L'Isle D'Abeau (FR); Pierre Piccaluga, Macon (FR)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 10/488,850

(22) PCT Filed: Sep. 5, 2002
(86) PCT No.: PCT/EP02/09939

(30) Foreign Application Priority Data
Sep. 5, 2001 (FR) 0111455

(51) Int. Cl. H04R 3/00

(52) U.S. Cl. 381/96; 381/111

(57) ABSTRACT

In pressure-free condition, music is produced automatically by resonance of free matter. In this instance of freedom, sound is produced and propagated. If a finger is softly placed on an excited resonating bell, the sound of the bell stops. In the field of electrical sound reproduction, the sound emitters such as loudspeaker diaphragms, are always excited by the following note and hardly have time to resonate. As opposed to musical instruments which require an escapement, the field of electrical sound reproduction disregards this. The present method aims at creating systematic micro-interruptions of the electric audio signal, thereby providing freedom to the diaphragm and an unhampered sound quality. Said micro-interruptions thus constitute the systematic acoustic artificial escapement of electroacoustic systems. Said micro-interruptions depend on the inertia of the transducer, but must be implemented at speeds of at least two to three times of the sound frequency activity of the transducer or of the acoustic enclosure. An adjustable electronic clock regularly monitors a unipolar or bipolar switch, in the form of an electric contact such as a transistor, which interrupts the electric system powering the enclosure. The diaphragms become actively resonant in normal mode, through the acoustic escapement which is useful to the whole acoustic and audio-visual world. Said escapement decreases the phenomenon of acoustic compression which causes deafness, and is therefore useful for the medical field.

### BACKGROUND OF THE INVENTION

All musical instrument acoustic systems have the particular feature of requiring to be musically excited through being struck, being activated by air or being initiated by a bow the strings of which strike cords. This principle in which tension is free to be released after having been created by a mechanical stress imposed by the musician, demonstrates how music resonates when unrestricted, by free resonance of matter accomplished by the music itself in a brief instant of relaxation. In this situation of unrestriction, the sound emanates and can propagate. If we consider the case of a bell that has been struck and is resonating, if we lightly touch it with the finger, the bell ceases to deliver sound. The sound no longer propagates; it is deadened, imprisoned.

In the field of electrical sound reproduction, sound emitters such as loudspeaker membranes always get excited from the note that follows and do not have any free time to resonate. Contrary to musical instruments which require an escapement, the sound reproduction field using electrical excitation overlooks this fact, although physically unavoidable. Electro-acoustic transducers made up by a coil and a magnet establish an unceasing and continuous constraint on the membrane which is constantly subject to the pressure from the driving force of the electrical audio signal and from uncontrolled micro-currents in the amplifiers driving them.

### SUMMARY OF THE INVENTION

The method disclosed herein consists in systematically creating micro-interruptions of the electrical audio signal giving the membrane its freedom and removing a limitation to sound quality, the membrane no longer being constrained and becoming available, able to breathe as it were and take up the space it needs. These micro-interruptions thus provide an artificial, systematic and acoustic escapement for electro-acoustic systems. The micro-interruptions depend on the inertia of the transducer, but should operate at speeds of at least two to three times the velocity of the sound frequency of the activity of the transducer or a loudspeaker.

This is in no way some system for regulating and controlling information to get a precise signal shape. It simply involves a systematic process the regular velocity of which is set as a function of the moving mass, and the constraints of transforming electrical energy into mechanical motion energy. The duration of interruption is approximately identical to the duration of activity, but can be half this if weight is low, the escapement, in other words the time during which the membrane is unrestricted without electrical drive, being instantaneous. The transducer is disconnected from its drive for a shorter period.

During this passive free phase, at least some resistance of very low impedance value is in series with the transducer or loudspeaker, said impedance being of the self-inductance or capacitive type, helps the escapement through its back EMF, thereby cancelling more rapidly the active audio modulation drive giving the membrane escapement its freedom for a very brief period of around the order of 100,000ths of a second. In effect, if the micro-interruptions are of at least twice the sound frequency of the transducer, to take for example mid-range frequencies of 15,000 Hz, the micro-interruption frequency which controls the escapement will be, if we take a figure of three times, 45,000 Hz. This escapement time can be half with an impedance, a wound resistance thus around some 90,000ths of a second or let us say 100,000ths of a second.

### DETAILED DESCRIPTION OF PREFERRED EMBODIMENT

Apparatus for carrying out the invention can be constructed by a person skilled in the art, and the example of an embodiment is non-limiting.

The apparatus constitutes an acoustic escapement for the sound reproduction field in which the drive for at least one electro-acoustic transducer or a 35 Hz to 20,000 Hertz active loudspeaker or acoustic enclosure is cut off for the duration of a systematic, repetitive and regular duration of a micro-interruption. A controllable electronic clock regularly drives a single- or double-pole switch in the form of an electrical on-off switch such as a transistor or a solid state switch which-shuts off the electrical drive circuit for the loudspeaker at a rate of one 80,000th of a second escapement and one 80,000th of a second activity. A 0.3 Ohm self-inductance coil is incorporated in series into the loudspeakers circuit. The self inductance reacts both to the current being switched on and off, and helps the escapement effect and active sound effect, through its induced back EMF, electrically in series with the loudspeaker coil or coils.

An apparatus and a method are provided for artificial acoustic escapement for sound reproduction allowing acoustic sonority which previously was kept prisoner as a result of constant electric activity to now manifest itself. Loudspeaker membranes become active through their own resonance, thanks to acoustic escapement useful for all areas of the acoustic and audio-visual field. As the escapement decreases acoustic compression phenomena which are a factor in deafness, the invention is useful also in the medical field.

1. A method for sound reproduction creating micro-interruptions in an electrical audio signal driving an electro-acoustic transducer or loudspeaker, said micro-interruptions constituting systematic artificial escapement and being controlled at rates of at least twice that of the frequency activity of the transducer or loudspeaker, allowing a membrane thereof freedom and removing restrictions on spatial sound quality.

2. The method according to claim 1, wherein at least one low resistance self-inductive or capacitive load is mounted in series with the still electrically-coupled acoustic transducer or loudspeaker whereby the back EMF resulting from said load reinforces the escapement effect.

3. Apparatus for sound reproduction comprising a controllable electronic clock regularly driving a solid-state electrical switch or a transistor for interrupting rhythm of at least twice a frequency rate of the sound activity thereof, whereby, to take the case of interruptions driven at one 80,000ths of a second corresponding to the escapement and with a period of activity identical thereto, restrictions on the sound quality of the membrane are lifted.

4. Apparatus according to claim 3, wherein a transducer or loudspeaker is provided with at least one impedance, wound resistance, for reinforcing the escapement activity.

5. The apparatus according to claim 3, for application in the medical field.
